(19) United States
(12) Patent Application Publication
(10) Pub. No.: US 2025/0070542 A1
(43) Pub. Date: Feb. 27, 2025

(54) COIL MANAGEMENT SYSTEM FOR VEHICLE

(71) Applicant: Oshkosh Corporation, Oshkosh, WI (US)

(72) Inventors: Robert Law, JR., Oshkosh, WI (US); Bogdan Marinoiu, Oshkosh, WI (US); David Roncin, Oshkosh, WI (US); Eric Hackenberg, Oshkosh, WI (US); Nick Jones, Oshkosh, WI (US)

(21) Appl. No.: 18/813,433

(22) Filed: Aug. 23, 2024

Related U.S. Application Data
(60) Provisional application No. 63/534,433, filed on Aug. 24, 2023.

(51) Int. Cl. H02G 11/00; B66F 11/04; F16L 3/015

(52) U.S. Cl. CPC H02G 11/006; F16L 3/015; B66F 11/044

(57) ABSTRACT

A vehicle includes a chassis, a chassis component coupled to the chassis, a turntable rotatably coupled to the chassis, a turntable component coupled to the turntable, and a flexible member assembly. The flexible member assembly has a first end portion coupled to the chassis, a second end portion coupled to the turntable, and a wound portion between the first end portion and the second end portion. The flexible member assembly includes a flexible member coupling the chassis component to the turntable component.

### CROSS-REFERENCE TO RELATED PATENT APPLICATION

This application claims the benefit of and priority to U.S. Provisional Application No. 63/534,433, filed on Aug. 24, 2023, the entire disclosure of which is hereby incorporated by reference herein.

### BACKGROUND

The present disclosure relates to vehicles, such as lift devices. More specifically, the present disclosure relates to a system for facilitating relative movement between a chassis and a turntable of a vehicle.

### SUMMARY

At least one embodiment relates to a vehicle including a chassis, a chassis component coupled to the chassis, a turntable rotatably coupled to the chassis, a turntable component coupled to the turntable, and a flexible member assembly. The flexible member assembly has a first end portion coupled to the chassis, a second end portion coupled to the turntable, and a wound portion between the first end portion and the second end portion. The flexible member assembly includes a flexible member coupling the chassis component to the turntable component.

Another embodiment relates to a lift device including a chassis, a chassis component coupled to the chassis, a turntable configured to rotate relative to the chassis about an axis of rotation, a lift assembly coupled to the turntable and including an actuator, a cable configured to transfer electrical energy between the chassis component and the actuator, a tray coupled to the chassis, a coil management arm coupled to the turntable, and a clamp radially offset from the axis of rotation. The cable has a first portion coupled to the chassis, a second portion, and a middle portion between the first portion and the second portion. The tray at least partially supports the middle portion of the cable. The clamp fixedly couples the second portion of the cable to the coil management arm. The coil management arm is configured to wrap the middle portion around the axis of rotation as the turntable rotates relative to the chassis.

Another embodiment relates to a coil management system for a vehicle including a cable extending between a chassis and a turntable. The coil management system includes a first clamp configured to couple a first end portion of the cable to the chassis of the vehicle, a coil management arm configured to be coupled to the turntable of the vehicle, a second clamp configured to fixedly couple a second end portion of the cable to the coil management arm, and a tray configured to be coupled to the chassis of the vehicle. The tray includes a horizontal support surface and a barrier extending upright from the horizontal support surface. The coil management arm is configured to cause the cable to wrap around the barrier in response to the turntable rotating relative to the chassis.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is a perspective view of a lift device, according to an exemplary embodiment.

FIG. 2 is a perspective view of a base of the lift device of FIG. 1.

FIG. 3 is a perspective view of an axle assembly of the lift device of FIG. 1.

FIG. 4 is a perspective view of a platform assembly of the lift device of FIG. 1.

FIG. 5 is a front section view of a coil management system that connects the base of FIG. 2 and a turntable of the lift device of FIG. 1, according to some embodiments.

FIG. 6 is an exploded view of the coil management system of FIG. 5.

FIG. 7 is a top section view of the coil management system of FIG. 5.

FIG. 8 is a perspective view of a portion of the coil management system of FIG. 5.

FIG. 9 is a perspective view of a coil management system that connects the base of FIG. 2 and the turntable of FIG. 5, according to another embodiment.

FIG. 10 is a front section view of the coil management system of FIG. 9 with the base of FIG. 2 and the turntable of FIG. 5.

FIGS. 11-13 are perspective views of the coil management system of FIG. 9.

FIG. 14 is a top view of the coil management system of FIG. 9.

FIG. 15 is a top view of the coil management system of FIG. 9.

FIG. 16 is a perspective view of a flexible member assembly of the coil management system of FIG. 9.

FIGS. 17-19 are perspective views of a tray and a coil management arm of the coil management system of FIG. 9.

### DETAILED DESCRIPTION

Before turning to the figures, which illustrate the exemplary embodiments in detail, it should be understood that the present disclosure is not limited to the details or methodology set forth in the description or illustrated in the figures. It should also be understood that the terminology used herein is for the purpose of description only and should not be regarded as limiting.

### Overview

Referring generally to the Figures, a coil management system is shown according to various exemplary embodiments. Some lift devices include a chassis or base assembly that rests on the ground (e.g., directly or through one or more tractive elements) and a turntable that is rotatable relative to the chassis. Some such lift devices include systems (e.g., hydraulic systems, pneumatic systems, electrical systems, etc.) that extend between the turntable and the chassis. In order to function, such systems may require electrical or fluid (e.g., hydraulic, pneumatic, etc.) communication between the lift assembly 14 and the base assembly 12 (e.g., for data communication, to transfer electrical energy, to transfer hydraulic power, etc.).

Some lift devices form such a connection by directly connecting a flexible member (e.g., a hose or cable) between a chassis and a turntable. However, relative rotation between the base and the turntable twists the hose or cable. Accordingly, the potential for damage to the flexible member caused by twisting the flexible member limits the maximum rotation of the turntable. This rotational limitation is undesirable, as a rotational limit may require an operator to reverse direction to avoid hitting an operating limit. In other lift devices, slip rings, rotary unions, rotary joints, or other rotational connectors are used to permit relative rotation of two or more wires or hoses. These rotational connectors permit unlimited rotation of the turntable relative to the base. However, such rotational connectors can be expensive, difficult to install, and prone to failure.

The coil management system according to various exemplary embodiments described herein improves on such systems by providing a coiled, flexible assembly. The flexible assembly includes one or more flexible members (e.g., conduits, hoses, wires, cables, etc.) connected to one another and arranged extending parallel to one another. One end of the flexible assembly is fixedly coupled to the chassis, and an opposing second end of the flexible assembly is fixedly coupled to the turntable. The flexible assembly is coiled around a vertical axis into a spiral arrangement and supported on a tray. As the turntable rotates relative to the chassis, the second end of the flexible assembly rotates about the vertical axis. When rotating in a first direction, the coil of the flexible assembly tightens (e.g., the spaces between the windings become smaller). When rotating in a second direction, the coil of the flexible assembly loosens (e.g., the spaces between the windings become tighter). This deformation is applied as a bending of the flexible assembly along the entire length of the coil, minimizing the strain effect of the rotation on the flexible members within the flexible assembly. Accordingly, the coil management system provides a much greater range of rotation (e.g., 360 degrees, 720 degrees, 1080 degrees, etc.) than an arrangement where a hose or cable extends directly between the chassis and the turntable. Due to the use of hoses and cables, the coil management system is more robust and cost-effective than using a rotational connector.

### Lift Device

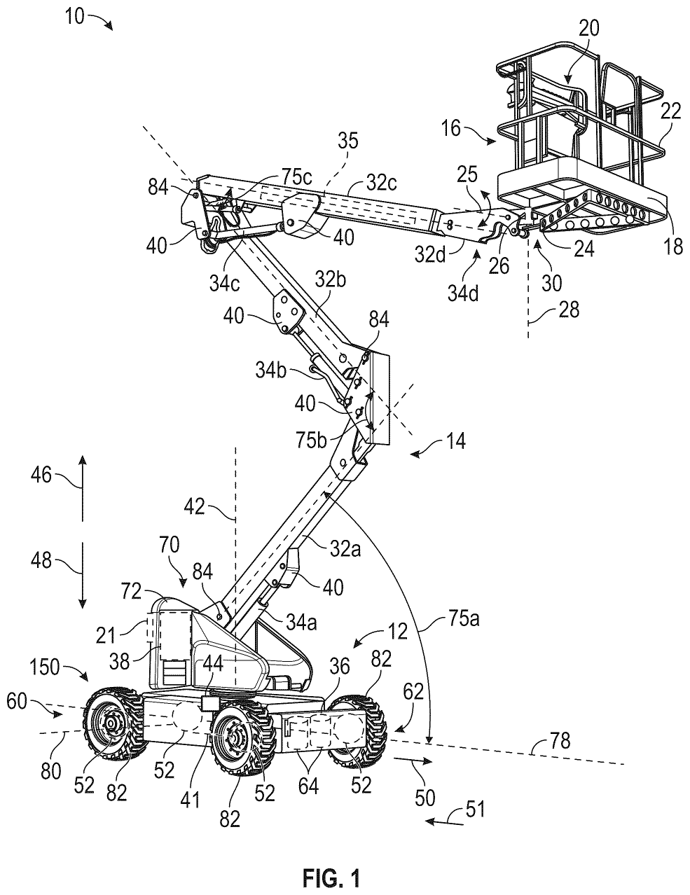

Referring to FIG. 1, a lifting apparatus, lift device, or mobile elevating work platform (MEWP) (e.g., a telehandler, an electric boom lift, a towable boom lift, a lift device, a fully electric boom lift, etc.), shown as lift device 10 includes a base assembly 12 (e.g., a base, a support assembly, a drivable support assembly, a support structure, a chassis, etc.), a platform assembly 16 (e.g., a platform, a terrace, etc.), and a lift assembly 14 (e.g., a boom, a boom lift assembly, a lifting apparatus, an articulated arm, a scissors lift, etc.). The lift device 10 includes a front end (e.g., a forward-facing end, a front portion, a front, etc.), shown as front 62, and a rear end (e.g., a rearward facing end, a back portion, a back, a rear, etc.,) shown as rear 60. The lift assembly 14 is configured to elevate the platform assembly 16 in an upward direction 46 (e.g., an upward vertical direction) relative to the base assembly 12. The lift assembly 14 is also configured to translate the platform assembly 16 in a downward direction 48 (e.g., a downward vertical direction). The lift assembly 14 is also configured to translate the platform assembly 16 in either a forward direction 50 (e.g., a forward longitudinal direction) or a rearward direction 51 (e.g., a rearward longitudinal direction). The lift assembly 14 generally facilitates performing a lifting function to raise and lower the platform assembly 16, as well as movement of the platform assembly 16 in various directions.

The base assembly 12 defines a longitudinal axis 78 and a lateral axis 80. The longitudinal axis 78 defines the forward direction 50 of lift device 10 and the rearward direction 51. The lift device 10 is configured to translate in the forward direction 50 and to translate backwards in the rearward direction 51. The base assembly 12 includes one or more wheels, tires, wheel assemblies, tractive elements, rotary elements, treads, etc., shown as tractive elements 82. The tractive elements 82 are configured to rotate to drive (e.g., propel, translate, steer, move, etc.) the lift device 10. The tractive elements 82 can each include an electric motor 52 (e.g., electric wheel motors) configured to drive the tractive elements 82 (e.g., to rotate tractive elements 82 to facilitate motion of the lift device 10). In other embodiments, the tractive elements 82 are configured to receive power (e.g., rotational mechanical energy) from electric motors 52 or through a drive train (e.g., a combination of any number and configuration of a shaft, an axle, a gear reduction, a gear train, a transmission, etc.). In some embodiments, one or more tractive elements 82 are driven by a prime mover 41 (e.g., electric motor, internal combustion engine, etc.) through a transmission. In some embodiments, a hydraulic system (e.g., one or more pumps, hydraulic motors, conduits, valves, etc.) transfers power (e.g., mechanical energy) from one or more electric motors 52 and/or the prime mover 41 to the tractive elements 82. The tractive elements 82 and electric motors 52 (or prime mover 41) can facilitate a driving and/or steering function of the lift device 10. In some embodiments, the electric motors 52 are optional, and the tractive elements 82 are powered or driven by an internal combustion engine.

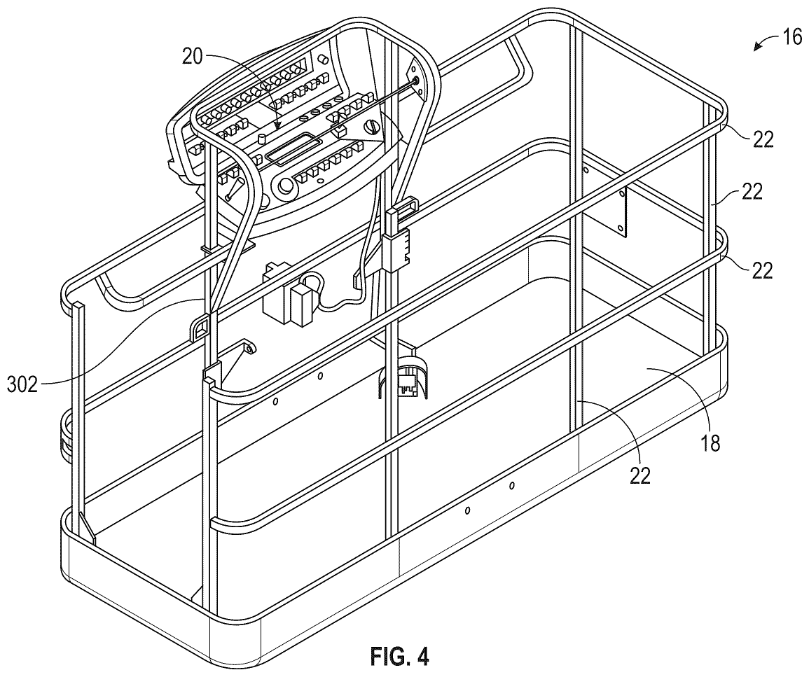

With additional reference to FIG. 4, the platform assembly 16 is shown in further detail. The platform assembly 16 is configured to provide a work area for an operator of the lift device 10 to stand/rest upon. The platform assembly 16 can be pivotally coupled to an upper end of the lift assembly 14. The lift device 10 is configured to facilitate the operator accessing various elevated areas (e.g., lights, platforms, the sides of buildings, building scaffolding, trees, power lines, etc.). The lift device 10 may use various electrically-powered motors and electrically-powered linear actuators or hydraulic cylinders to facilitate elevation and/or horizontal movement (e.g., lateral movement, longitudinal movement) of the platform assembly 16 (e.g., relative to the base assembly 12, or to a ground surface that the base assembly 12 rests upon). In some embodiments, the lift device 10 uses internal combustion engines, hydraulics, a hydraulic system, pneumatic cylinders, etc.

The platform assembly 16 includes a base member, a base portion, a platform, a standing surface, a shelf, a work platform, a floor, a deck, etc., shown as a deck 18. The deck 18 provides a space (e.g., a floor surface) for a worker to stand upon as the platform assembly 16 is raised and lowered.

The platform assembly 16 includes a railing assembly including various members, beams, bars, guard rails, rails, railings, etc., shown as rails 22. The rails 22 extend along substantially an entire perimeter of the deck 18. The rails 22 provide one or more members for the operator of the lift device 10 to grasp while using the lift device 10 (e.g., to grasp while operating the lift device 10 to elevate the platform assembly 16). The rails 22 can include members that are substantially horizontal to the deck 18. The rails 22 can also include vertical structural members that couple with the substantially horizontal members. The vertical structural members can extend upwards from the deck 18.

The platform assembly 16 can include a human machine interface (HMI) (e.g., a user interface, an operator interface, etc.), shown as the user interface 20. The user interface 20 is configured to receive user inputs from the operator at or upon the platform assembly 16 to facilitate operation of the lift device 10. The user interface 20 can include any number of buttons, levers, switches, keys, etc., or any other user input device configured to receive a user input to operate the lift device 10. The user interface 20 may also provide information to the user (e.g., through one or more displays, lights, speakers, haptic feedback devices, etc.). The user interface 20 can be supported by one or more of the rails 22.

Referring to FIG. 1, the platform assembly 16 includes a frame 24 (e.g., structural members, support beams, a body, a structure, etc.) that extends at least partially below the deck 18. The frame 24 can be integrally formed with the deck 18. The frame 24 is configured to provide structural support for the deck 18 of the platform assembly 16. The frame 24 can include any number of structural members (e.g., beams, bars, I-beams, etc.) to support the deck 18. The frame 24 couples the platform assembly 16 with the lift assembly 14. The frame 24 may be rotatably or pivotally coupled with the lift assembly 14 to facilitate rotation of the platform assembly 16 about an axis 28 (e.g., a vertical axis). The frame 24 can also rotatably/pivotally couple with the lift assembly 14 such that the frame 24 and the platform assembly 16 can pivot about an axis 25 (e.g., a horizontal axis).

The lift assembly 14 includes one or more beams, articulated arms, bars, booms, arms, support members, boom sections, cantilever beams, etc., shown as lift arms 32a, 32b, and 32c. The lift arms are hingedly or rotatably coupled with each other at their ends. The lift arms can be hingedly or rotatably coupled to facilitate articulation of the lift assembly 14 and raising/lowering and/or horizontal movement of the platform assembly 16. The lift device 10 includes a lower lift arm 32a, a central or medial lift arm 32b, and an upper lift arm 32c. The lower lift arm 32a is configured to hingedly or rotatably couple at one end with the base assembly 12 to facilitate lifting (e.g., elevation) of the platform assembly 16. The lower lift arm 32a is configured to hingedly or rotatably couple at an opposite end with the medial lift arm 32b. Likewise, the medial lift arm 32b is configured to hingedly or rotatably couple with the upper lift arm 32c. The upper lift arm 32c can be configured to hingedly interface/couple and/or telescope with an intermediate lift arm 32d. The upper lift arm 32c can be referred to as “the jib” of the lift device 10. The intermediate lift arm 32d may extend into an inner volume of the upper lift arm 32c and extend and/or retract. The lower lift arm 32a and the medial lift arm 32b may be referred to as “the boom” of the overall lift device 10 assembly. The intermediate lift arm 32d can be configured to couple (e.g., rotatably, hingedly, etc.), with the platform assembly 16 to facilitate levelling of the platform assembly 16.

The lift arms 32 are driven to hinge or rotate relative to each other by actuators 34a, 34b, 34c, and 34d (e.g., electric linear actuators, linear electric arm actuators, hydraulic cylinders, etc.). The actuators 34a, 34b, 34c, and 34d can be mounted between adjacent lift arms to drive adjacent lift arms to hinge or pivot (e.g., rotate some angular amount) relative to each other about pivot points 84. The actuators 34a, 34b, 34c, and 34d can be mounted between adjacent lift arms using any of a foot bracket, a flange bracket, a clevis bracket, a trunnion bracket, etc. The actuators 34a, 34b, 34c, and 34d may be configured to extend or retract (e.g., increase in overall length, or decrease in overall length) to facilitate pivoting adjacent lift arms to pivot/hinge relative to each other, thereby articulating the lift arms and raising or lowering the platform assembly 16.

The actuators 34a, 34b, 34c, and 34d can be configured to extend (e.g., increase in length) to increase a value of an angle formed between adjacent lift arms 32. The angle can be defined between centerlines of adjacent lift arms 32 (e.g., centerlines that extend substantially through a center of the lift arms 32). For example, the actuator 34a is configured to extend/retract to increase/decrease the angle 75a defined between a centerline of the lower lift arm 32a and the longitudinal axis 78 (angle 75a can also be defined between the centerline of the lower lift arm 32a and a plane defined by the longitudinal axis 78 and lateral axis 80) and facilitate lifting of the platform assembly 16 (e.g., moving the platform assembly 16 at least partially along the upward direction 46). Likewise, the actuator 34b can be configured to retract to decrease the angle 75a to facilitate lowering of the platform assembly 16 (e.g., moving the platform assembly 16 at least partially along the downward direction 48). Similarly, the actuator 34b is configured to extend to increase the angle 75b defined between centerlines of the lower lift arm 32a and the medial lift arm 32b and facilitate elevating of the platform assembly 16. Similarly, the actuator 34b is configured to retract to decrease the angle 75b to facilitate lowering of the platform assembly 16. The electric actuator 34c is similarly configured to extend/retract to increase/decrease the angle 75c, respectively, to raise/lower the platform assembly 16. The actuators 34 may be hydraulic actuators, electric actuators, pneumatic actuators, etc.

The actuators 34a, 34b, 34c, and 34d can be mounted (e.g., rotatably coupled, pivotally coupled, etc.) to adjacent lift arms at mounts 40 (e.g., mounting members, mounting portions, attachment members, attachment portions, etc.). The mounts 40 can be positioned at any position along a length of each lift arm. For example, the mounts 40 can be positioned at a midpoint of each lift arm, and a lower end of each lift arm.

The intermediate lift arm 32d and the frame 24 are configured to pivotally interface/couple at a platform rotator 30 (e.g., a rotary actuator, a rotational electric actuator, a gear box, etc.). The platform rotator 30 facilitates rotation of the platform assembly 16 about the axis 28 relative to the intermediate lift arm 32d. In some embodiments, the platform rotator 30 is positioned between the frame 24 and the upper lift arm 32c and facilitates pivoting of the platform assembly 16 relative to the upper lift arm 32c. The axis 28 extends through a central pivot point of the platform rotator 30. The intermediate lift arm 32d can also be configured to articulate or bend such that a distal portion of the intermediate lift arm 32d pivots/rotates about the axis 25. The intermediate lift arm 32d can be driven to rotate/pivot about axis 25 by extension and retraction of the actuator 34d.

The intermediate lift arm 32d is also configured to extend/retract (e.g., telescope) along the upper lift arm 32c. In some embodiments, the lift assembly 14 includes a linear actuator (e.g., a hydraulic cylinder, an electric linear actuator, etc.), shown as extension actuator 35, that controls extension and retraction of the intermediate lift arm 32d relative to the upper lift arm 32c. In other embodiments, one more of the other arms of the lift assembly 14 include multiple telescoping sections that are configured to extend/retract relative to one another.

The platform assembly 16 is configured to be driven to pivot about the axis 28 (e.g., rotate about axis 28 in either a clockwise or a counter-clockwise direction) by an electric or hydraulic motor 26 (e.g., a rotary electric actuator, a stepper motor, a platform rotator, a platform electric motor, an electric platform rotator motor, etc.). The motor 26 (e.g., the pivot motor 26) can be configured to drive the frame 24 to pivot about the axis 28 relative to the upper lift arm 32c (or relative to the intermediate lift arm 32d). The motor 26 can be configured to drive a gear train to pivot the platform assembly 16 about the axis 28.

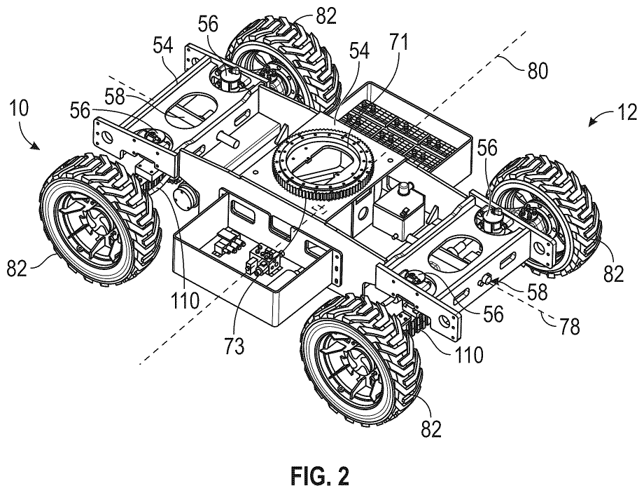

Referring to FIGS. 1 and 2, the lift assembly 14 is configured to pivotally or rotatably couple with the base assembly 12. The base assembly 12 includes a rotatable base member, a rotatable platform member, a fully electric turntable, etc., shown as a turntable 70. The lift assembly 14 is configured to rotatably/pivotally couple with the base assembly 12. The turntable 70 is rotatably coupled with a base, frame, structural support member, carriage, etc., of base assembly 12, shown as base 36. The turntable 70 is configured to rotate or pivot relative to the base 36. The turntable 70 can pivot/rotate about the central axis 42 relative to base 36, about a slewing bearing 71 (e.g., the slewing bearing 71 pivotally couples the turntable 70 to the base 36). The turntable 70 facilitates accessing various elevated and angularly offset locations at the platform assembly 16. The turntable 70 is configured to be driven to rotate or pivot relative to base 36 and about the slewing bearing 71 by an electric motor, an electric turntable motor, an electric rotary actuator, a hydraulic motor, etc., shown as the turntable motor 44. The turntable motor 44 can be configured to drive a geared outer surface 73 of the slewing bearing 71 that is rotatably coupled to the base 36 about the slewing bearing 71 to rotate the turntable 70 relative to the base 36. The lower lift arm 32a is pivotally coupled with the turntable 70 (or with a turntable member 72 of the turntable 70) such that the lift assembly 14 and the platform assembly 16 rotate as the turntable 70 rotates about the central axis 42. In some embodiments, the turntable 70 is configured to rotate a complete 360 degrees about the central axis 42 relative to the base 36. In other embodiments, the turntable 70 is configured to rotate an angular amount less than 360 degrees about the central axis 42 relative to the base 36 (e.g., 270 degrees, 120 degrees, etc.).

The base assembly 12 includes one or more energy storage devices or power sources (e.g., capacitors, batteries, Lithium-Ion batteries, Nickel Cadmium batteries, fuel tanks, etc.), shown as batteries 64. The batteries 64 are configured to store energy in a form (e.g., in the form of chemical energy) that can be converted into electrical energy for the various electric motors and actuators of the lift device 10. The batteries 64 can be stored within the base 36. The lift device 10 includes a controller 38 that is configured to operate any of the motors, actuators, etc., of the lift device 10. The controller 38 can be configured to receive sensory input information from various sensors of the lift device 10, user inputs from the user interface 20 (or any other user input device such as a key-start or a push-button start), etc. The controller 38 can be configured to generate control signals for the various motors, actuators, etc., of the lift device 10 to operate any of the motors, actuators, electrically powered movers, etc., of the lift device 10. The batteries 64 are configured to power any of the motors, sensors, actuators, electric linear actuators, electrical devices, electrical movers, stepper motors, etc., of the lift device 10. The base assembly 12 can include a power circuit including any necessary transformers, resistors, transistors, thermistors, capacitors, etc., to provide appropriate power (e.g., electrical energy with appropriate current and/or appropriate voltage) to any of the motors, electric actuators, sensors, electrical devices, etc., of the lift device 10.

The batteries 64 are configured to deliver power to the motors 52 to drive the tractive elements 82. A rear set of tractive elements 82 can be configured to pivot to steer the lift device 10. In other embodiments, a front set of tractive elements 82 are configured to pivot to steer the lift device 10. In still other embodiments, both the front and the rear set of tractive elements 82 are configured to pivot (e.g., independently) to steer the lift device 10. In some examples, the base assembly 12 includes a steering system 150. The steering system 150 is configured to drive the tractive elements 82 to pivot for a turn of the lift device 10. The steering system 150 can be configured to pivot the tractive elements 82 in pairs (e.g., to pivot a front pair of tractive elements 82), or can be configured to pivot the tractive elements 82 independently (e.g., four-wheel steering for tight-turns).

It should be understood that while the lift device 10 as described herein is described with reference to batteries, electric motors, etc., the lift device 10 can be powered (e.g., for transportation and/or lifting the platform assembly 16) using one or more internal combustion engines, electric motors or actuators, hydraulic motors or actuators, pneumatic actuators, or any combination thereof.

In some embodiments, the base assembly 12 also includes a user interface 21 (e.g., a HMI, a user interface, a user input device, a display screen, etc.). In some embodiments, the user interface 21 is coupled to the base 36. In other embodiments, the user interface 21 is positioned on the turntable 70. The user interface 21 can be positioned on any side or surface of the base assembly 12 (e.g., on the front 62 of the base 36, on the rear 60 of the base 36, etc.).

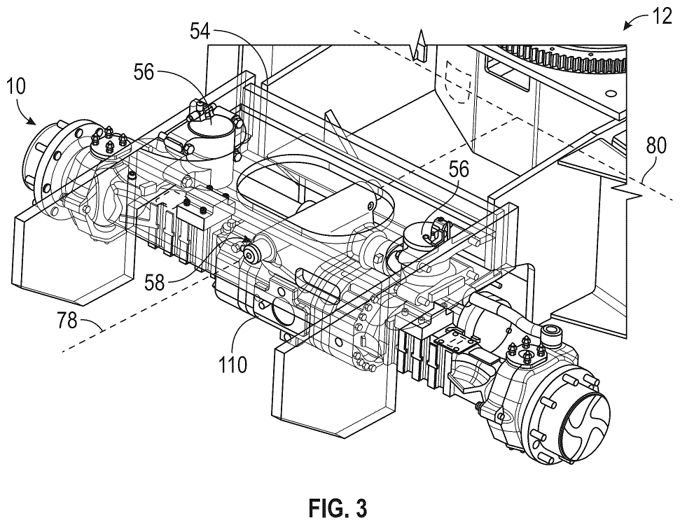

Referring now to FIGS. 2 and 3, the base assembly 12 includes a longitudinally extending frame member 54 (e.g., a rigid member, a structural support member, an axle, a base, a frame, a carriage, a chassis, etc.). The longitudinally extending frame member 54 provides structural support for the turntable 70 as well as the tractive elements 82. The longitudinally extending frame member 54 is pivotally coupled with lateral frame members 110 (e.g., axles, frame members, beams, bars, etc.) at opposite longitudinal ends of the longitudinally extending frame member 54. For example, the lateral frame members 110 may be pivotally coupled with the longitudinally extending frame member 54 at a front end and a rear end of the longitudinally extending frame member 54. The lateral frame members 110 can each be configured to pivot about a pivot joint 58 (e.g., about a longitudinal axis). The pivot joint 58 can include a pin and a receiving portion (e.g., a bore, an aperture, etc.). The pin of the pivot joint 58 is coupled to one of the lateral frame members 110 (e.g., a front lateral frame member 110 or a rear lateral frame member 110) or the longitudinally extending frame member 54 and the receiving portion is coupled to the other of the longitudinally extending frame member 54 and the lateral frame member 110. For example, the pin may be coupled with longitudinally extending frame member 54 and the receiving portion can be coupled with one of the lateral frame members 110 (e.g., integrally formed with the front lateral frame member 110).

In some embodiments, the longitudinally extending frame member 54 and the lateral frame members 110 are integrally formed or coupled (e.g., fastened, welded, riveted, etc.) to define the base 36. In still other embodiments, the base 36 is integrally formed with the longitudinally extending frame member 54 and/or the lateral frame members 110. In still other embodiments, the base 36 is coupled with the longitudinally extending frame member 54 and/or the lateral frame members 110.

The base assembly 12 includes one or more axle actuators 56 (e.g., electric linear actuators, electric axle actuators, electric levelling actuators, hydraulic cylinders, etc.). The axle actuators 56 can be linear actuators configured to receive power from the batteries 64, for example. The axle actuators 56 can be configured to extend or retract to contact a top surface of a corresponding one of the lateral frame members 110. When the axle actuators 56 extend, an end of a rod of the levelling actuators can contact the surface of lateral frame member 110 and prevent relative rotation between lateral frame member 110 and longitudinally extending frame member 54. In this way, the relative rotation/pivoting between the lateral frame member 110 and the longitudinally extending frame member 54 can be locked (e.g., to prevent rolling of the longitudinally extending frame member 54 relative to the lateral frame members 110 during operation of the lift assembly 14). The axle actuators 56 can receive power from the batteries 64, which can allow the axle actuators 56 to extend or retract. The axle actuators 56 receive control signals from controller 38.

### Hose and Cable Management System

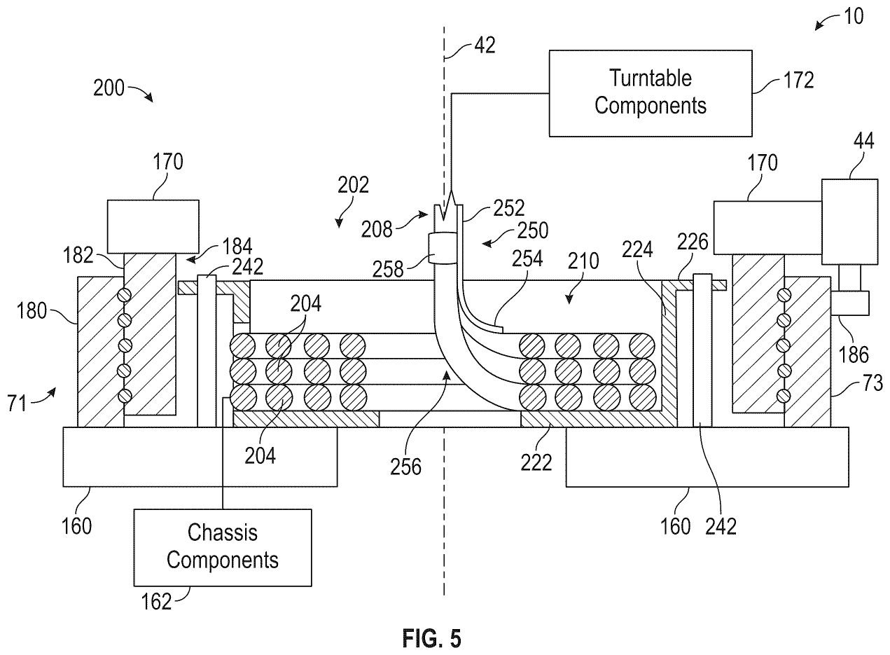

Referring to FIG. 5, a schematic section view of the lift device 10 is shown according to an exemplary embodiment. The lift device 10 includes one or more chassis components 162 coupled to a base member or chassis 160 of the lift device 10 and one or more turntable components 172 coupled to a turntable 170. The lift device 10 of FIG. 5 may represent the lift device of FIGS. 1-4, another lift device, or another type of vehicle (e.g., a fire truck, a military vehicle, a refuse vehicle, a concrete mixing truck, a crane, another type of vehicle where power transmission between two rotating components is desirable, etc.). The chassis 160 may represent one or more components of the base assembly 12 (e.g., the frame member 54, the lateral frame members 110, etc.). The turntable 170 may represent any part of the lift assembly 14 (e.g., the turntable 70, the turntable member 72, etc.).

The chassis components 162 and the turntable components 172 may include any components that perform functions within the lift device. The chassis components 162 and the turntable components 172 may include electrical components (e.g., batteries, motors, generators, controllers, shore power connectors, solar panels, power converters (e.g., inverters, rectifiers, transformers, DC-DC converters), etc.), hydraulic components (e.g., actuators, motors, pumps, valves, reservoirs, accumulators, etc.), and/or pneumatic components (e.g., actuators, motors, pumps, valves, reservoirs, accumulators, etc.). By way of example, the chassis components 162 may include the user interface 21, the controller 38, the prime mover 41, the electric motors 52, the axle actuators 56, the steering system 150, and/or other components. The turntable components 172 may include the user interface 20, the hydraulic motor 26, the actuators 34, the extension actuator 35, the turntable motor 44, and/or other components.

Referring still to FIG. 5, the slewing bearing 71 rotatably couples the chassis 160 to the turntable 170, such that the turntable 170 is rotatable relative to the chassis 160 about the central axis 42. Accordingly, the slewing bearing 71 may be centered about the central axis 42. The slewing bearing 71 includes a first portion or fixed portion, shown as outer race 180, that is fixedly coupled to the chassis 160. The slewing bearing 71 further includes a second portion or rotatable portion, shown as inner race 182, that is fixedly coupled to the turntable 170. The inner race 182 is received within the outer race 180 and rotatably coupled to the outer race 180 (e.g., by a series of bearing elements, such as ball bearings or rollers, etc.). The inner race 182 has an inner surface that defines a substantially cylindrical inner volume, shown as bearing volume 184.

The outer race 180 defines a geared outer surface 73 (i.e., a surface including a series of gear teeth). A body of the turntable motor 44 is fixedly coupled to the turntable 170. An output shaft of the turntable motor 44 is coupled to a pinion gear 186 that engages the geared outer surface 73 of the outer race 180. Accordingly, when the turntable motor 44 is operated, the pinion gear 186 rotates to drive rotation of the inner race 182 and the turntable 170 relative to the outer race 180 and the chassis 160. In other embodiments, the body of the turntable motor 44 is fixedly coupled to the chassis 160.

Referring to FIGS. 5-7, the lift device 10 includes a hose and cable management system, rotatable connection, rotatable coupler assembly, or flexible member coiling system, shown as coil management system 200. The coil management system 200 includes a flexible member assembly 202 that includes one or more flexible members (e.g., conduits, hoses, wires, cables, etc.), shown as flexible members 204, that are fixedly coupled (e.g., bonded) to one another. The flexible members 204 generally extend parallel to one another (e.g., a section of one flexible member 204 is parallel to an adjacent section of another flexible member 204).

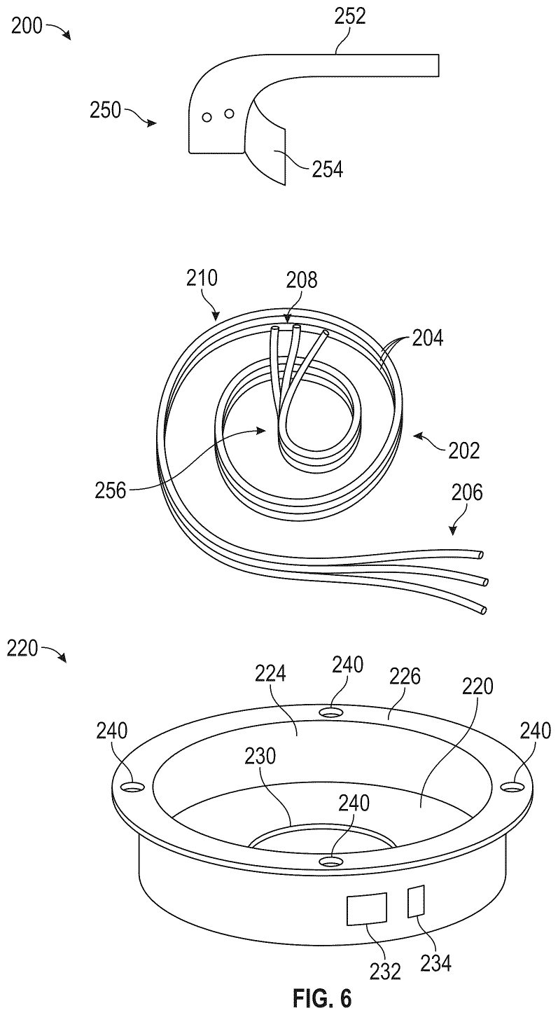

In FIGS. 5 and 6, the flexible member assembly 202 is shown to include three flexible members 204. In other embodiments, the flexible member assembly 202 includes more or fewer flexible members 204 (e.g., one, two, four, ten, etc.). The number of flexible members 204 may depend on the number of functions or components that are connected by the flexible member assembly 202 (e.g., a greater number of connected components may utilize a greater number of flexible members 204).

The flexible member assembly 202 may include one or more different types of flexible members 204 based on the desired type of transfer between the chassis components 162 and the turntable components 172. By way of example, the flexible member assembly 202 may include one or more hoses or fluid conduits to transfer a liquid such as hydraulic oil (e.g., as part of a hydraulic system) or water or a compressed gas (e.g., as part of a pneumatic system). By way of another example, the flexible member assembly 202 may include one or more wires or cables to transfer electrical energy. By way of another example, the flexible member assembly 202 may include one or more wires, cables, or optical fibers to transfer data. The flexible member assembly 202 may include a single type of flexible member 204 or a combination of one or more different types of flexible members 204 (e.g., hoses, wires, and optical fibers, etc.).

A first end portion, shown as base end 206, of the flexible member assembly 202 is fixedly coupled to the base assembly 12. An opposing second end portion, shown as turntable end 208, of the flexible member assembly 202 is fixedly coupled to the turntable 170. A middle portion or coiled portion, shown as wound portion 210, is formed from a middle section of the flexible member assembly 202. The wound portion 210 is located between the base end 206 and the turntable end 208. The wound portion 210 of the flexible member assembly 202 is coiled or wound around the central axis 42 into a spiral or clockspring shape that gradually decreases in diameter from the base end 206 to the turntable end 208. The wound portion 210 may form one or more complete wraps, each wrap representing 360 degrees of rotation around the central axis 42. Increasing the number of wraps may increase the length of the flexible member assembly 202.

As shown in FIG. 5, the portion of each flexible member 204 that forms the wound portion 210 generally occupies a different horizontal plane. The flexible members 204 are vertically offset from one another, such that the flexible members stack atop of one another. Each flexible member 204 may be fixedly coupled (e.g., adhered, bonded, etc.) to the adjacent flexible members 204 to form the flexible member assembly 202. Because the flexible members 204 occupy different planes, additional flexible members 204 can be stacked without interfering with the coiling of one another. Advantageously, the number of flexible members 204 can be scaled in this way to suit the desired application of the coil management system 200 (e.g., for a particular vehicle).

The flexible member assembly 202 is supported by a hose and cable tray or hose management tray, shown as tray 220. The tray 220 includes a bottom wall, shown as support wall 222, a cylindrical wall or upright wall, shown as sidewall 224, and a top portion or flange, shown as mounting flange 226. In some embodiments, the support wall 222, the sidewall 224, and the mounting flange 226 are fixedly coupled to one another and formed as a single continuous piece.

The support wall 222 generally extends within a horizontal plane below the flexible member assembly 202, such that the flexible member assembly 202 rests atop the support wall 222. Accordingly, the support wall 222 limits downward movement of the flexible member assembly 202. In some embodiments, the support wall 222 and/or the flexible member assembly 202 are configured (e.g., coated in a lubricant) to facilitate relative sliding motion between the support wall 222 and the flexible member assembly 202. The support wall 222 is circular and substantially centered about the central axis 42. In some embodiments, the support wall 222 defines a central aperture 230 that facilitates access through the tray 220 (e.g., for maintenance, to provide clearance for components, etc.).

The sidewall 224 extends upward from an outer circumference of the support wall 222. The sidewall 224 is generally annular and cylindrical. In some embodiments, the sidewall 224 is substantially centered about the central axis 42. The sidewall 224 limits outward radial movement of the flexible member assembly 202. Accordingly, the wound portion 210 of the flexible member assembly 202 is contained within a volume at least partially defined by the sidewall 224 and the support wall 222.

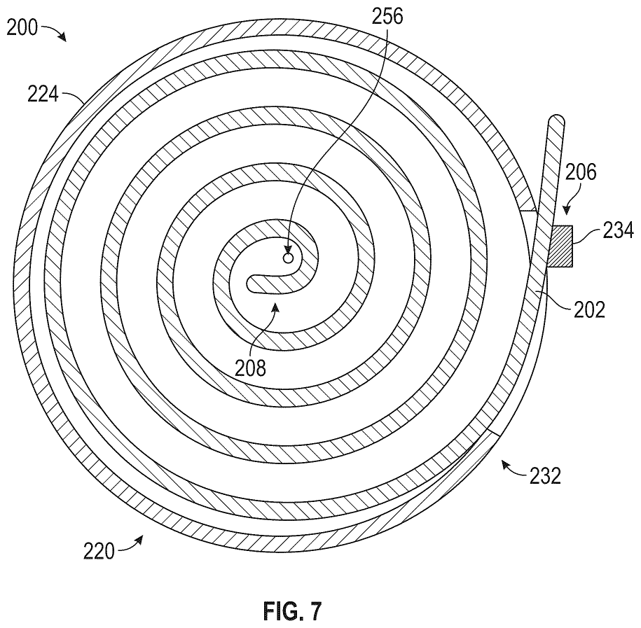

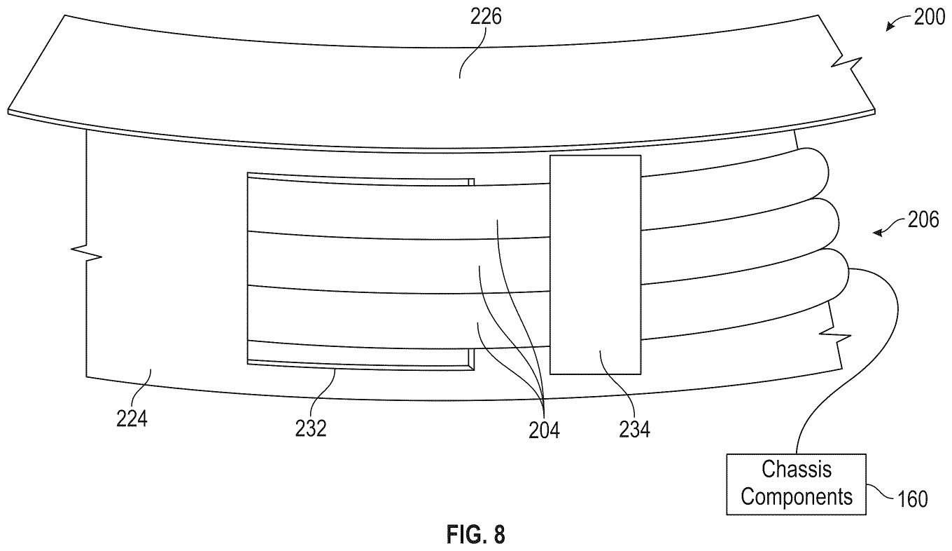

As shown in FIGS. 7 and 8, the sidewall 224 defines a passthrough aperture, shown as sidewall aperture 232. The sidewall aperture 232 extends radially through the sidewall 224. The base end 206 of the flexible member assembly 202 passes through the sidewall aperture 232, permitting the base end 206 to exit the tray 220. A mount, shown as clamp 234, is coupled to the sidewall 224. As the base end 206 passes out of the sidewall aperture 232, the base end 206 extends generally tangent to an outer surface of the sidewall 224. The base end 206 of the flexible member assembly 202 is received between the clamp 234 and the sidewall 224, and the clamp 234 is tightened to fixedly couple the base end 206 to an outer surface of the sidewall 224. Accordingly, the tray 220 fixes the base end 206 in place.

Referring to FIGS. 5 and 6, the mounting flange 226 generally extends in a horizontal plane above the support wall 222 and extends radially outward from the sidewall 224. The mounting flange 226 defines a series of apertures, shown as mounting holes 240, extending vertically through the mounting flange 226. A series of fasteners, shown as standoffs 242, extend through the mounting holes 240 and fixedly couple the mounting flange 226 to the chassis 160.

Accordingly, the tray 220 fixedly couples the base end 206 of the flexible member assembly 202 to the chassis components 162. With the base end 206 fixed in place, the flexible members 204 may be coupled to the chassis components 162. Due to the position of the clamp 234, the wound portion 210 and the turntable end 208 can move freely relative to the tray 220 without the movement disturbing (e.g., applying stresses to) the connection between the base end 206 and the chassis components 162.

The coil management system 200 further includes a turntable mounting bracket or hose management arm, shown as coil management arm 250, that guides the turntable end 208 of the flexible member assembly 202. The coil management arm is 250 is fixedly coupled to the turntable 170, such that the coil management arm 250 rotates relative to the tray 220 and the chassis 160. The coil management arm 250 extends radially inward from the turntable 170 toward the central axis 42 to engage the turntable end 208. The coil management arm 250 holds the turntable end 208 vertically along the central axis 42, such that the tray 220 and the wound portion 210 rotate about the turntable end 208.

The coil management arm 250 includes a first portion, shown as flat portion 252, and a second portion, shown curved portion 254. The turntable end 208 of the flexible member assembly 202 extends along one or more surfaces of the flat portion 252 and the curved portion 254, such that the coil management arm 250 helps to shape the flexible member assembly 202. The flexible member assembly 202 has an upward bend 256, at which the flexible members 204 transition from extending within a horizontal plane to extending vertically. The upward bend 256 engages the curved portion 254, and the shape of the curved portion 254 forms the upward bend 256. After completing the upward bend 256, the flexible member assembly 202 extends vertically along the flat portion 252.

In some embodiments, the flexible member assembly 202 includes a thermally-sensitive material, such as a thermoplastic, that can be temporarily made more flexible by applying thermal energy to the material. In such an embodiment, the shape of the upward bend 256 may be formed by applying thermal energy to the flexible member assembly 202 and placing the flexible member assembly 202 in a fixture corresponding to the predetermined, desired shape of the upward bend 256. After the flexible member assembly 202 is allowed to cool, the flexible member assembly 202 may be removed from the fixture and coupled to the coil management arm 250. In this way, both the coil management arm 250 and the heat forming of the thermoplastic help to retain the desired shape of the upward bend 256.

The coil management arm 250 further includes a mount, shown as clamp 258, that is coupled to the flat portion 252. As the turntable end 208 extends above the upward bend 256, the turntable end 208 extends generally vertically along the flat portion 252. The turntable end 208 of the flexible member assembly 202 is received between the clamp 258 and the flat portion 252, and the clamp 258 is tightened to fixedly couple the turntable end 208 to the coil management arm 250. Accordingly, the coil management arm 250 fixes the turntable end 208 in place. With the turntable end 208 fixed in place, the flexible members 204 may be coupled to the turntable components 172. Due to the position of the clamp 258, the wound portion 210 and the base end 206 can move freely relative to the coil management arm 250 without the movement disturbing (e.g., applying stresses to) the connection between the turntable end 208 and the turntable components 172.

During operation, the turntable 170 rotates relative to the chassis 160 (e.g., under power of the turntable motor 44). This relative rotation causes the base end 206 to move relative to the turntable end 208 in a circular path centered about the central axis 42. Because the base end 206 and the turntable end 208 are fixed, this motion causes the wound portion 210 to twist. As the wound portion 210 twists, the wraps of the wound portion 210 tighten or loosen based on the direction of rotation of the turntable 170. By way of example, in the arrangement shown in FIG. 7, rotating the turntable 170 clockwise causes the wound portion 210 to tighten (i.e., the wraps within the wound portion 210 move closer together), and rotating the turntable 170 counterclockwise causes the wound portion 210 to loosen (i.e., the wraps within the wound portion 210 move farther apart).

The coil management system 200 provides various advantages over other systems for connecting turntable and chassis components. By way of example, the coil management system 200 may provide a larger range of motion for the turntable 170 than other systems. By way of another example, the coil management system 200 may reduce component wear.

Due to the spiral arrangement of the wound portion 210, this twisting movement causes the flexible members 204 to bend around the central axis 42. Advantageously, this bending is experienced by the entirety of the wound portion 210 simultaneously, spreading the strain imparted on the flexible members 204 along the entire length of the flexible member assembly 202 and minimizing the stress experienced by the flexible members 204. Because of this, the turntable 170 can rotate through a large range of motion (e.g., 360 degrees, 720 degrees, 1080 degrees, etc.) before the stresses experienced by the flexible member assembly 202 cause damage to the flexible members 204.

Each of the flexible members 204 may have a minimum allowable bend radius to prevent damage. By way of example, a hose may have a minimum allowable bend radius that is required to prevent the hose kinking and limiting flow. By way of another example, a cable may have a minimum allowable bend radius required to prevent breaking of wires within the cable. This spiral arrangement of the wound portion 210 causes the entire wound portion 210 to bend simultaneously, maximizing the bend radius of each flexible member 204 and thereby maximizing the range of motion before the minimum bend radius is experienced.

In some embodiments, the flexible members 204 are bonded to one another, limiting (e.g., preventing) relative movement of the flexible members 204 in a given cross section of the flexible member assembly 202. By bonding the flexible members 204 together, the flexible members 204 are held in the stacked coil arrangement shown in FIG. 5. Without the bonding, the flexible members 204 could move relative to one another and interfere with the spiral coiling action of the wound portion 210. Additionally, the stacked arrangement of the flexible members 204 ensures that only the bottommost flexible member 204 contacts the support wall 222, preventing frictional wear on the other flexible members 204.

Because the flexible member assembly 202 is contained within the tray 220, the flexible members 204 are protected from contacting sharp edges or other abrasive materials that would cause wear on the flexible members 204. Instead, the flexible member assembly 202 slides across the flat surface of the support wall 222. Accordingly, the arrangement of the tray 220 limits wear on the coil management system 200 and improves system longevity.

Some lift devices form a connection between a turntable component and a chassis component by directly connecting a flexible member (e.g., a hose or cable) between a chassis and a turntable without the coiled arrangement of the coil management system 200. In such a configuration, relative rotation between the base and the turntable twists the flexible member along its length instead of bending the flexible member. This twisting configuration may impart larger stresses on the flexible member than the coiled arrangement of the coil management system 200. Accordingly, the coil management system 200 may improve the durability and the range of motion of a turntable system.

In other lift devices, slip rings, rotary unions, rotary joints, or other rotational connectors are used to permit relative rotation of two or more wires or hoses. These rotational connectors permit unlimited rotation of the turntable relative to the base. However, such rotational connectors can be expensive, difficult to install, and prone to failure. In contrast, the coil management system 200 utilizes hoses and/or cables, which is more cost-effective and robust than a rotational connector arrangement.

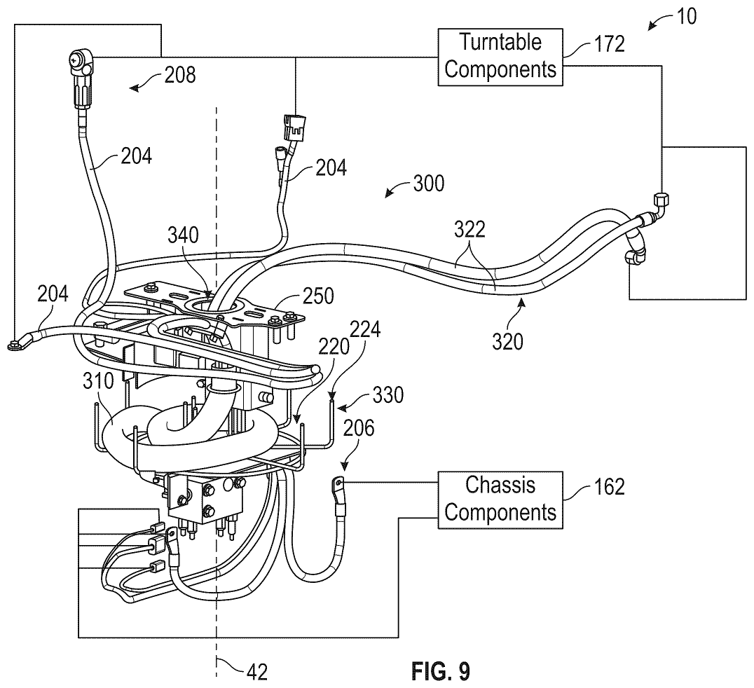

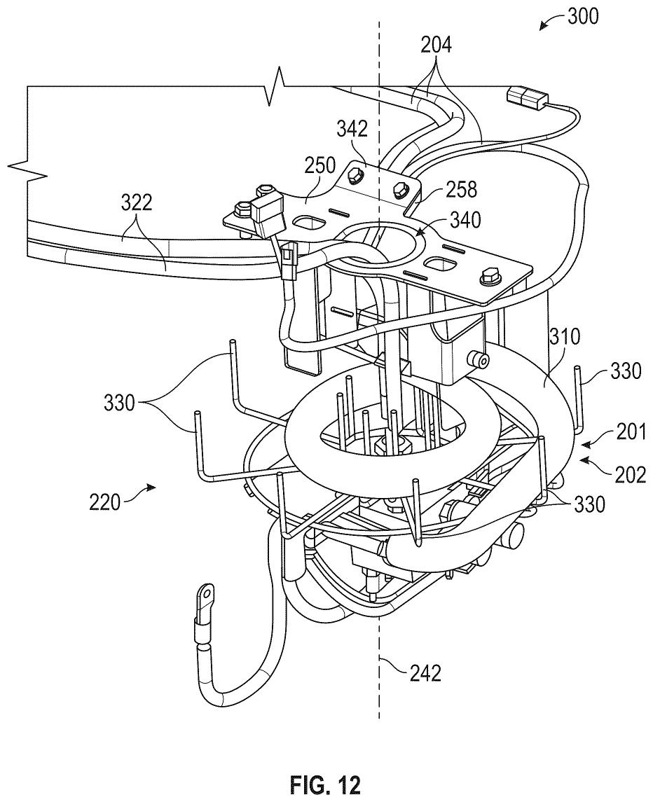

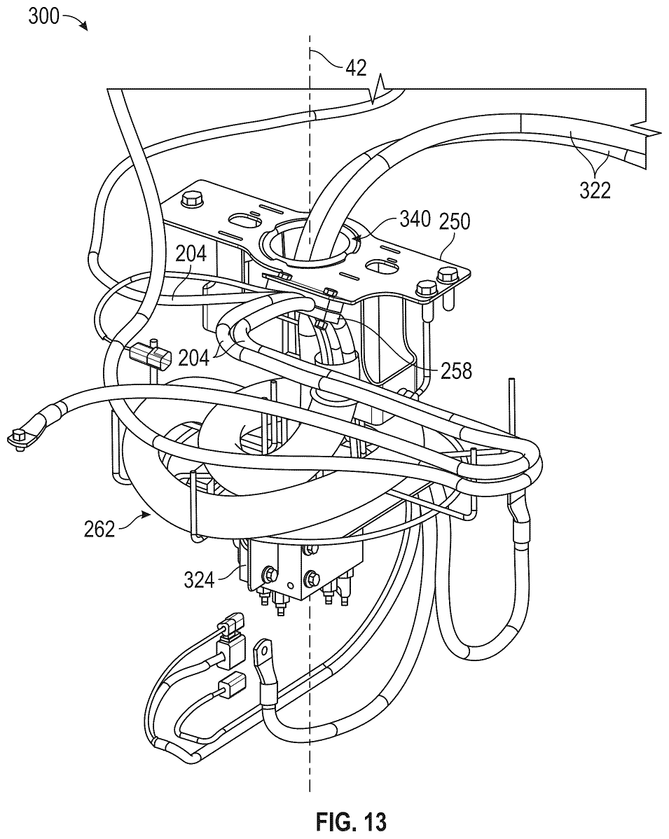

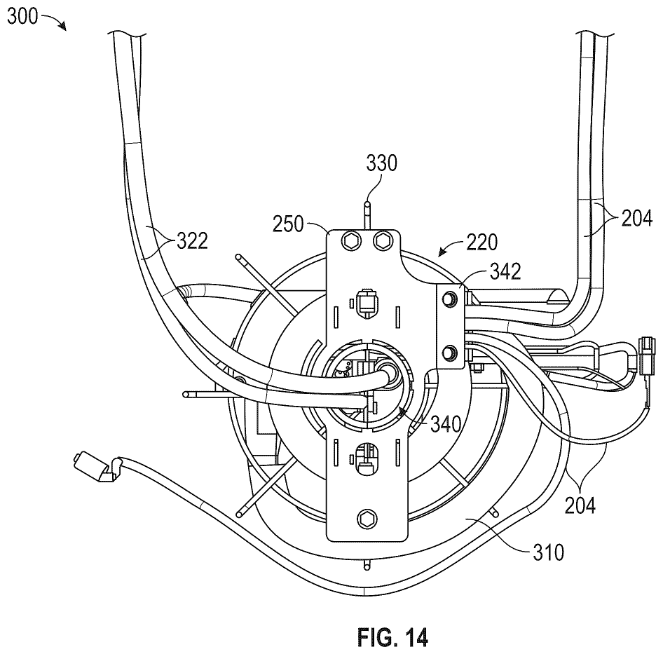

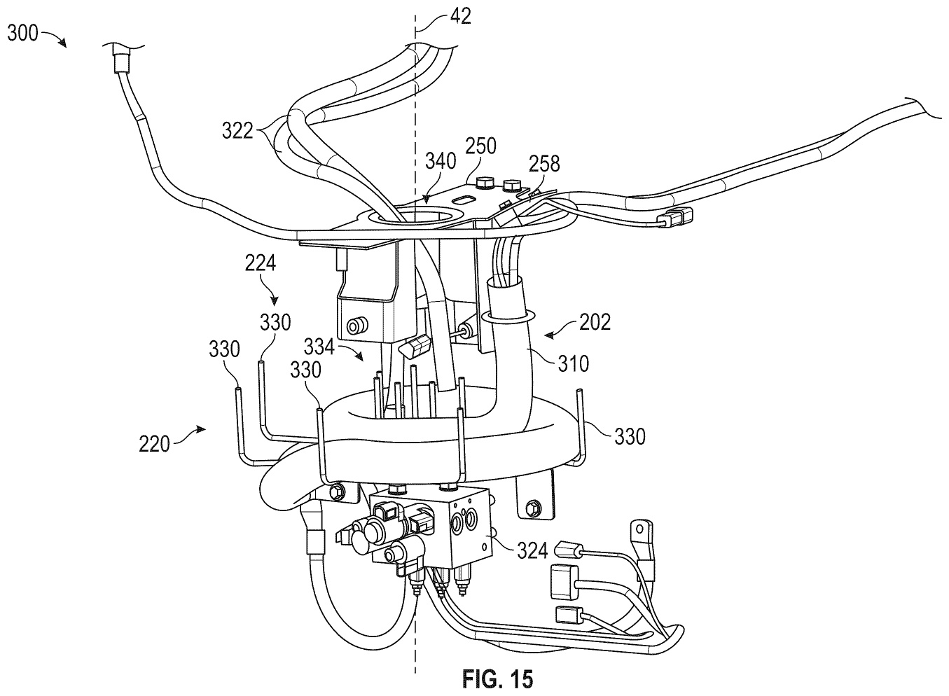

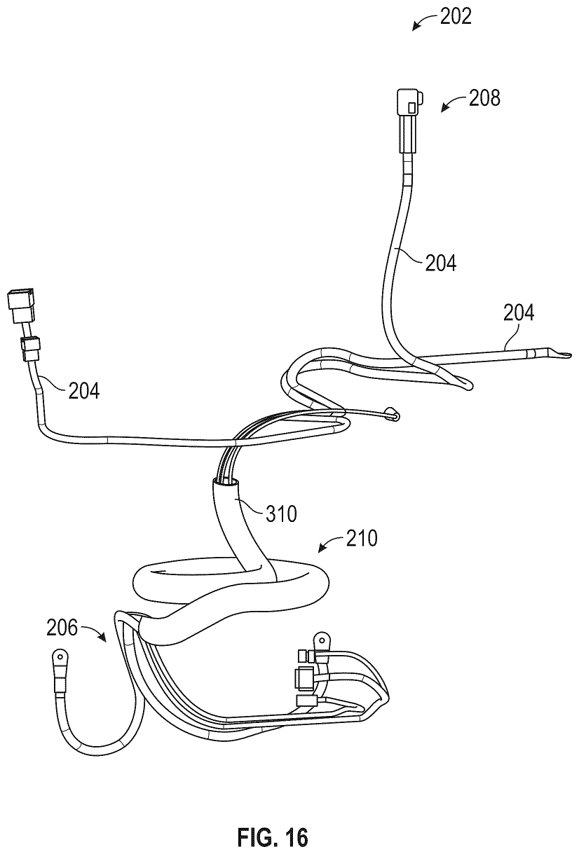

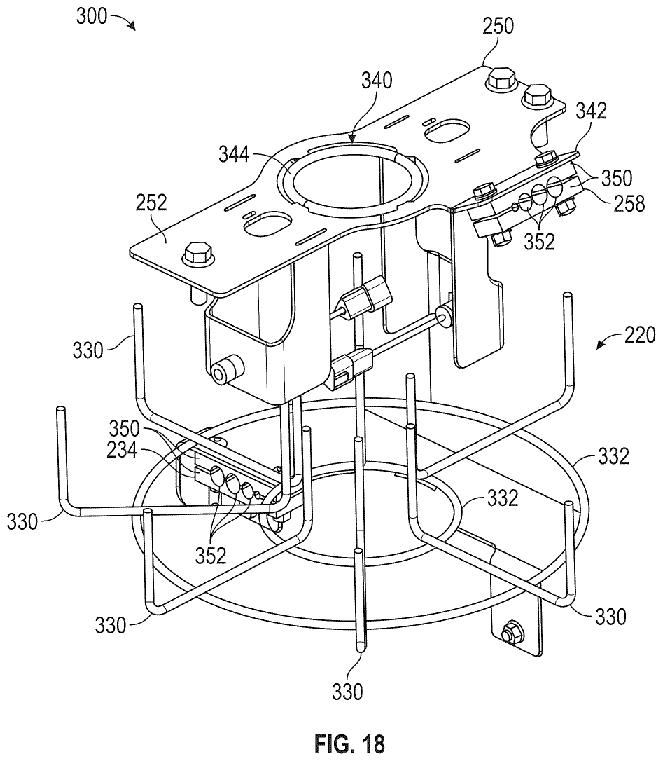

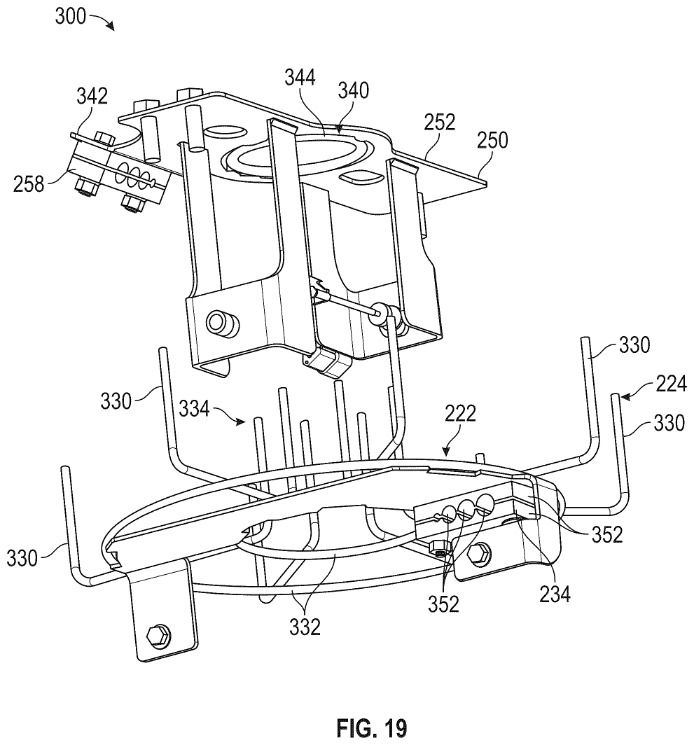

Referring to FIGS. 9-19, a hose and cable management system, rotatable connection, rotatable coupler assembly, or flexible member coiling system is shown as coil management system 300 according to an exemplary embodiment. The coil management system 300 is an alternative configuration of the coil management system 200. Accordingly, the coil management system 300 may be substantially similar to the coil management system 200 except as otherwise specified herein.

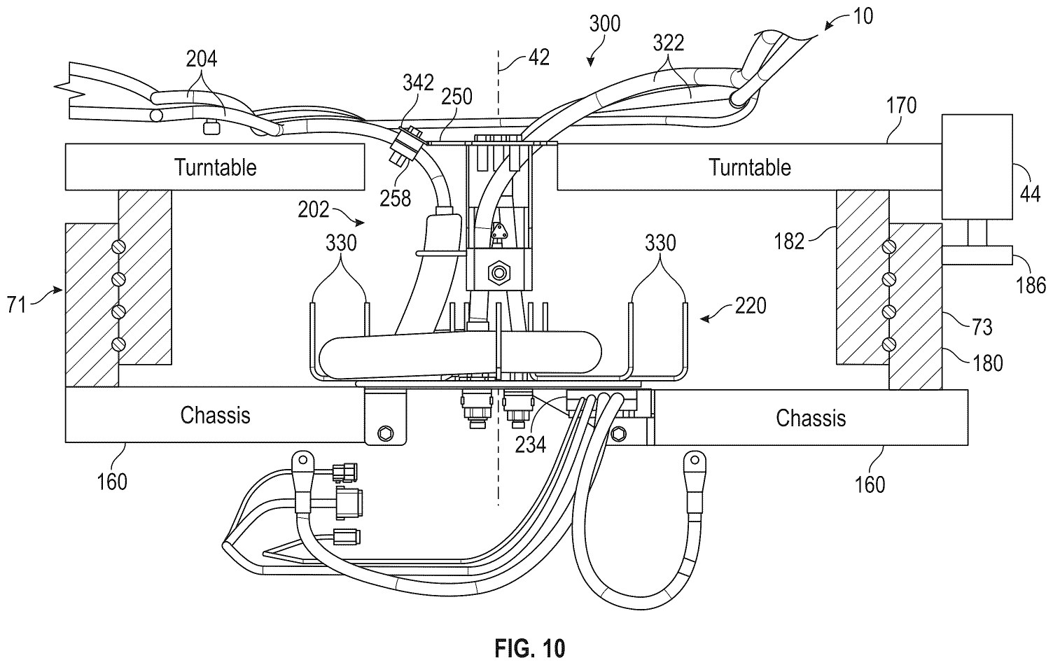

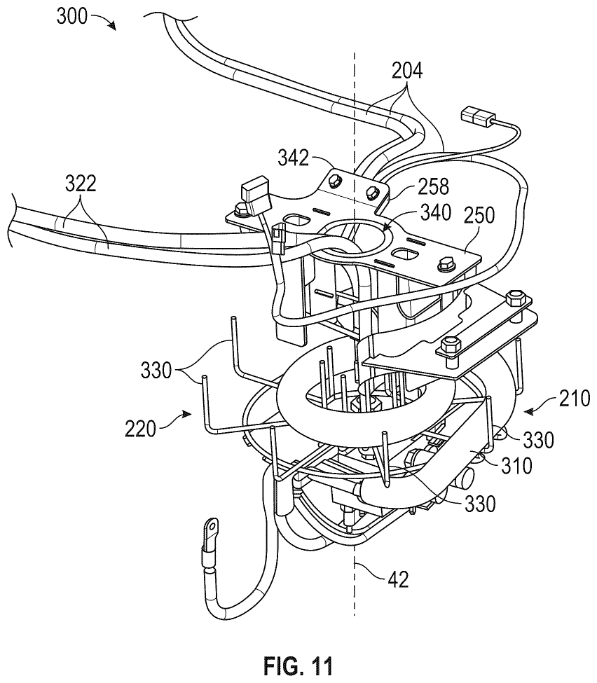

FIGS. 9 and 10 illustrate the coil management system 300 installed within the lift device 10. Specifically, FIG. 9 illustrates the coil management system 300 operatively coupling the chassis components 162 and the turntable components 172 of the lift device 10. FIG. 10 illustrates the coil management system 300 coupled to the chassis 160 and the turntable 170 of the lift device 10 and extending within the slewing bearing 71 of the lift device 10. FIGS. 11-19 illustrate the coil management system 300 separate from the lift device 10.

Referring to FIGS. 9-16, the coil management system 300 includes a flexible member assembly 202, which may be substantially similar to the flexible member assembly 202 of the coil management system 200 except as otherwise specified herein. The flexible member assembly 202 includes a series of flexible members 204. As shown, the flexible members 204 are each configured as cables that transfer electrical energy and/or signals (e.g., data) between the chassis components 162 and the turntable components 172. In other embodiments, the flexible members 204 include one or more hoses. By way of example, the flexible members 204 may include only hoses, or the flexible members 204 may include a mixture of hoses and cables. As shown, the wound portion 210 of the flexible member assembly 202 forms one complete wrap around the central axis 42.

The flexible member assembly 202 further includes a guard, shield, protector, or wear portion, shown as sleeve 310. The sleeve 310 is a tubular member that receives the flexible members 204 therethrough. Specifically, the sleeve 310 has a first end portion and a second end portion each defining a corresponding aperture. The flexible members 204 enter the sleeve 310 through the aperture of the first end portion and exit the sleeve 310 through the aperture of the second end portion. Accordingly, the sleeve 310 extends along and covers the wound portion 210 of the flexible member assembly 202.

The sleeve 310 surrounds the flexible members 204, providing a barrier to protect the flexible members 204 from wear that might otherwise occur from friction during repeated movement (e.g., winding and winding of the flexible member assembly 202) or potential punctures from contact with debris. The sleeve 310 also bundles the flexible members 204, applying an inward radial force to compress the flexible members 204 together. In some embodiments, the sleeve 310 fixedly couples the flexible members 204 to one another. To facilitate bending of the flexible members 204, the sleeve 310 may be constructed from a flexible material (e.g., rubber, plastic, a woven material such as fabric, etc.).

Referring to FIGS. 9-15 and 17, the coil management system 300 further includes a secondary flexible member assembly, shown as flexible member assembly 320. The flexible member assembly 320 includes a series of flexible members 322 (e.g., hoses, cables, etc.). As shown, the flexible members 322 are each configured as hoses that transfer fluid between the chassis components 162 and the turntable components 172. The flexible members 322 are fluidly coupled to a flow control component, manifold, or valve element, shown as valve block 324, that is fixedly coupled to the chassis 160. In other embodiments, the flexible members 322 include one or more cables.

The flexible members 322 extend upward from the valve block 324 along the central axis 42. The wound portion 210 of the flexible member assembly 202 is wound around the flexible members 322, such that the flexible members 322 extend through an aperture formed by winding the flexible members 204. In some embodiments, the flexible members 322 and the flexible members 204 are separately coupled to the turntable 170, such that rotation of the turntable 170 causes the flexible members 204 to move relative to the flexible members 322 (e.g., winding or winding the flexible members 204 around the flexible members 322). In some such embodiments, the flexible members 322 remain stationary relative to the chassis 160 when the turntable 170 rotates.

Referring to FIGS. 9-15 and 17-19, the coil management system 300 includes a hose and cable tray or hose management tray, shown as tray 220, which may be substantially similar to the tray 220 of the coil management system 200 except as otherwise specified herein. The tray 220 is fixedly coupled to the chassis 160. The tray 220 is formed from a series of spokes, tines, ribs, members, or bars, shown as upright bars 330 and annular bars 332. The annular bars 332 extend within a substantially horizontal plane and are substantially concentric with one another (e.g., centered about the central axis 42). The upright bars 330 are fixedly coupled (e.g., welded) to the annular bars 332 and extend upward from the annular bars 332. Each upright bar 330 is u-shaped and includes a horizontal portion and a pair of vertical portions extending upward from the horizontal portion.

The upright bars 330 form a bottom wall, shown as support wall 222, an outer cylindrical wall or upright wall, shown as sidewall 224, and an inner cylindrical wall or upright wall, shown as sidewall 334. Specifically, the horizontal portions of the upright bars 330 extend generally within a horizontal plane below the flexible member assembly 202 to form the support wall 222. The first vertical portions of the upright bars 330 are spaced a first distance from the central axis 42 to form the sidewall 224. The second vertical portions of the upright bars 330 are spaced a second distance from the central axis 42 to form the sidewall 334. The second distance is less than the first distance, such that the sidewall 334 is the closest wall to the central axis 42. By forming the tray 220 using a series of bars, a series of apertures are formed between the bars (e.g., between the upright bars 330 and the annular bars 332, between adjacent upright bars 330, etc.). The upright bars 330 of the tray 220 support and contain the flexible member assembly 202, while the apertures between the bars permit debris (e.g., plant matter, construction debris, rocks, etc.) to exit the tray 220 instead of being captured within the tray 220.

During operation, the flexible member assembly 202 rests atop the support wall 222, and the support wall 222 limits downward movement of the flexible member assembly 202. The flexible member assembly 202 may be held in place against the support wall 222 by the force of gravity acting on the flexible member assembly 202. The sidewall 224 limits outward radial movement of the flexible member assembly 202. The sidewall 334 limits inward radial movement of the flexible member assembly 202. Accordingly, the wound portion 210 of the flexible member assembly 202 is contained within a volume at least partially defined by the sidewall 224, the sidewall 334, and the support wall 222. If the wound portion 210 increases or decreases in diameter as the turntable 170 rotates, the sidewall 224 and the sidewall 334 prevent the wound portion 210 from falling off of the support wall 222.

As shown in FIGS. 11-19, the base end 206 of the flexible member assembly 202 exits the tray 220 through the sidewall 224 by passing between a pair of the upright bars 330 that are adjacent to one another. A clamp 234 is positioned along an underside of the tray 220 and fixedly coupled to the tray 220 such that the clamp 234 is oriented substantially horizontally. The clamp 234 is radially offset from the central axis 42 to facilitate the clamp 234 aligning with the base end 206 immediately after the base end 206 separates from the wound portion 210. A portion of the base end 206 that passes between the upright bars 330 is covered by the sleeve 310 (e.g., to protect the flexible members 204 from wearing as the flexible member assembly 202 rubs against the tray 220). The base end 206 then exits the sleeve 310, and the individual flexible members 204 pass beneath the support wall 222 of the tray 220 and are received within the clamp 234. The clamp 234 is tightened to fixedly couple the base end 206 to the tray 220 and the chassis 160.

The coil management system 300 further includes a turntable mounting bracket or hose management arm, shown as coil management arm 250, which may be substantially similar to the coil management arm 250 of the coil management system 200 except as otherwise specified herein. The coil management arm 250 guides the turntable end 208 of the flexible member assembly 202. The coil management arm is 250 is fixedly coupled to the turntable 170, such that the coil management arm 250 rotates relative to the tray 220 and the chassis 160. The coil management arm 250 is substantially centered about the central axis 42.

The coil management arm 250 includes a first portion, shown as flat portion 252, that defines a passage shown as passthrough aperture 340, and a second portion (e.g., a tab, plate, or protrusion), shown as clamp plate 342. The flat portion 252 extends substantially horizontally. The clamp plate 342 extends upward and outward (i.e., is inclined) relative to the flat portion 252. In some embodiments, the flat portion 252 and the clamp plate 342 are integrally formed as a single, continuous piece (e.g., from a piece of bent sheet metal).

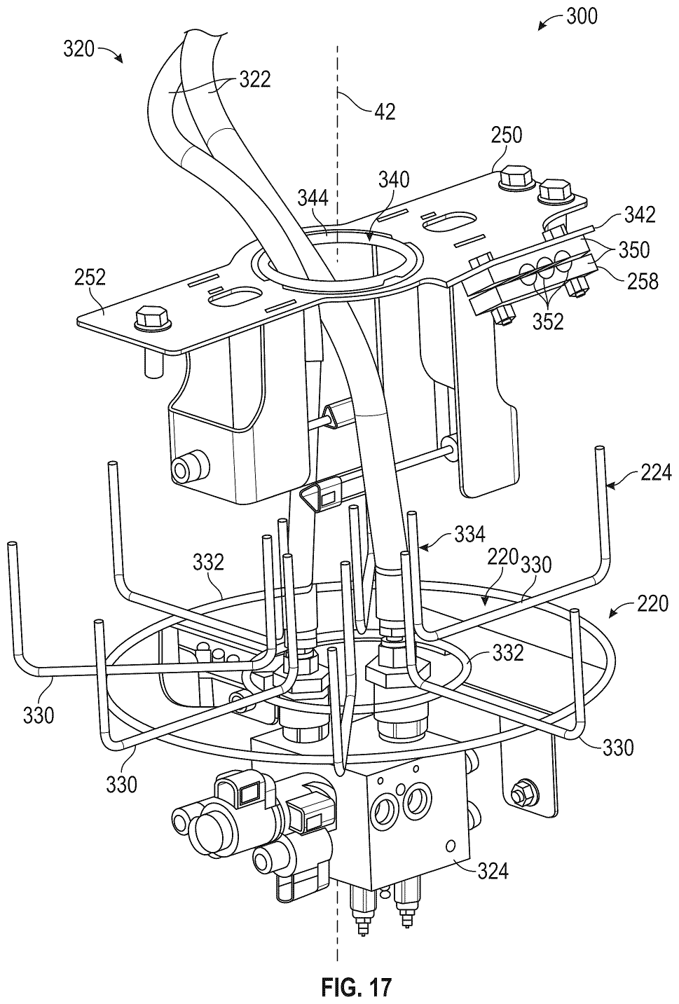

As shown in FIGS. 17-19, the passthrough aperture 340 extends vertically through the flat portion 252 and is substantially centered about the central axis 42. The passthrough aperture 340 is surrounded by a bearing member, shown as ring 344. The flexible members 322 extend through the passthrough aperture 340, permitting the flexible members 322 to reach the turntable 170. In embodiments where the turntable 170 rotates relative to the flexible members 322, the ring 344 may provide a smooth surface for the flexible members 322 to rest against, avoiding wear caused by the relative motion of the coil management arm 250 and the flexible members 322.

The coil management system 300 further includes a mount, shown as clamp 258, that is coupled to an underside of the clamp plate 342. The turntable end 208 of the flexible member assembly 202 is received by the clamp 258, and the clamp 258 is tightened to fixedly couple the turntable end 208 to the coil management arm 250. Accordingly, the coil management arm 250 fixes the turntable end 208 to the turntable 170. With the turntable end 208 fixed in place, the flexible members 204 may be coupled to the turntable components 172. The clamp 258 is radially offset from the central axis 42 to facilitate the clamp 258 aligning with the turntable end 208 immediately after the turntable end 208 separates from the wound portion 210. As shown in FIGS. 10-15, the inclined orientation of the clamp plate 342 causes the flexible members 204 to be directed upward and laterally outward from the coil management arm 250.

The clamp 234 and clamp 258 of the coil management system 300 each include a pair of clamping bodies or plates, shown as clamp bodies 350, that are selectively forced toward one another by a pair of fasteners. Each of the clamp bodies 350 defines series of hemicylindrical recesses, and the recesses of both clamp bodies 350 align with one another to form a series of flexible member passages 352. Each of the flexible member passages 352 receives one of the flexible members 204, and the fasteners may be tightened to fixedly couple the flexible members 204 to the clamp bodies 350 and hold the flexible members 204 in place.

During operation, the turntable 170 rotates relative to the chassis 160 (e.g., under power of the turntable motor 44). This relative rotation causes the base end 206 to move relative to the turntable end 208 in a circular path centered about the central axis 42. Because the base end 206 and the turntable end 208 are fixed, this motion causes the wound portion 210 to twist and tighten or loosen based on the direction of rotation of the turntable 170. In some embodiments, the coil management system 300 permits at least 360 degrees of rotation of the turntable 170. In some such embodiments, the coil management system 300 permits at least 400 degrees of rotation of the turntable 170.

### Configuration of the Exemplary Embodiments

As utilized herein with respect to numerical ranges, the terms “approximately,” “about,” “substantially,” and similar terms generally mean +/−10% of the disclosed values. When the terms “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure.

It is important to note that the construction and arrangement of the lift device 10 and coil management system 200 as shown in the various exemplary embodiments is illustrative only. Additionally, any element disclosed in one embodiment may be incorporated or utilized with any other embodiment disclosed herein.

What is claimed is:

1. A vehicle comprising:
a chassis;
a chassis component coupled to the chassis;
a turntable rotatably coupled to the chassis;
a turntable component coupled to the turntable; and
a flexible member assembly having a first end portion coupled to the chassis, a second end portion coupled to the turntable, and a wound portion between the first end portion and the second end portion, the flexible member assembly including a flexible member coupling the chassis component to the turntable component.

2. The vehicle of claim 1, wherein the flexible member includes at least one of (a) a hose fluidly coupling the chassis component to the turntable component or (b) a cable electrically coupling the chassis component to the turntable component.

3. The vehicle of claim 2, wherein the flexible member includes the cable electrically coupling the chassis component to the turntable component.

4. The vehicle of claim 1, further comprising a tray coupled to the chassis and at least partially supporting the wound portion of the flexible member assembly.

5. The vehicle of claim 4, wherein the turntable is rotatable relative to the chassis about a substantially vertical axis, wherein the tray includes an inner wall a first distance from the substantially vertical axis, an outer wall a second distance from the substantially vertical axis, and a bottom wall extending between the inner wall and the outer wall, wherein the wound portion is positioned between the inner wall and the outer wall, and wherein the bottom wall at least partially supports the wound portion.

6. The vehicle of claim 5, further comprising a clamp fixedly coupling the first end portion of the flexible member assembly to the chassis, and wherein the flexible member assembly engages the clamp below the bottom wall.

7. The vehicle of claim 1, wherein the flexible member is a first flexible member, wherein the flexible member assembly further includes a second flexible member fixedly coupled to the first flexible member.

8. The vehicle of claim 7, further comprising a sleeve extending along the wound portion of the flexible member assembly and receiving the first flexible member and the second flexible member.

9. The vehicle of claim 1, wherein the wound portion of the flexible member assembly forms at least one complete wrap.

10. The vehicle of claim 9, wherein the turntable is rotatable relative to the chassis about a substantially vertical axis, and wherein the at least one complete wrap surrounds the substantially vertical axis.

11. The vehicle of claim 10, further comprising a second member including at least one of a hose or a cable coupling the chassis component to the turntable component, wherein the at least one complete wrap surrounds the second member.

12. The vehicle of claim 11, further comprising a coil management arm coupled to the turntable and a clamp fixedly coupling the second end portion of the flexible member assembly to the coil management arm, wherein the coil management arm defines a passthrough aperture, and wherein the second member extends through the passthrough aperture.

13. The vehicle of claim 12, wherein the substantially vertical axis extends through the passthrough aperture.

14. The vehicle of claim 12, wherein the coil management arm includes a first portion that extends substantially horizontally and a second portion coupled to the clamp, wherein the second portion is oriented such that the second end portion of the flexible member assembly extends upward and away from the first portion of the coil management arm.

15. The vehicle of claim 1, wherein the flexible member assembly permits the turntable to rotate more than 360 degrees relative to the chassis.

16. The vehicle of claim 1, wherein the turntable component is an actuator, and wherein the flexible member is configured to transfer at least one of fluid or electrical energy to the actuator.

17. The vehicle of claim 16, wherein the vehicle is a lift device including a lift assembly coupled to the turntable, and wherein the actuator is configured to move a portion of the lift assembly relative to the turntable.

18. A lift device comprising:
a chassis;
a chassis component coupled to the chassis;
a turntable configured to rotate relative to the chassis about an axis of rotation;
a lift assembly coupled to the turntable, the lift assembly including an actuator;
a cable configured to transfer electrical energy between the chassis component and the actuator, the cable having a first portion coupled to the chassis, a second portion, and a middle portion between the first portion and the second portion;
a tray coupled to the chassis and at least partially supporting the middle portion of the cable;
a coil management arm coupled to the turntable; and
a clamp radially offset from the axis of rotation and fixedly coupling the second portion of the cable to the coil management arm,
wherein the coil management arm is configured to wrap the middle portion around the axis of rotation as the turntable rotates relative to the chassis.

19. The lift device of claim 18, wherein the tray includes a barrier that extends between the middle portion of the cable and the axis of rotation.

20. A coil management system for a vehicle including a cable extending between a chassis and a turntable, the coil management system comprising:
a first clamp configured to couple a first end portion of the cable to the chassis of the vehicle;
a coil management arm configured to be coupled to the turntable of the vehicle;
a second clamp configured to fixedly couple a second end portion of the cable to the coil management arm; and
a tray configured to be coupled to the chassis of the vehicle, the tray including a horizontal support surface and a barrier extending upright from the horizontal support surface,
wherein the coil management arm is configured to cause the cable to wrap around the barrier in response to the turntable rotating relative to the chassis.
